(19) United States
(12) Patent Application Publication
(10) Pub. No.: US 2026/0209121 A1
(43) Pub. Date: Jul. 23, 2026

(54) CERAMIC ARTICLE AND METHOD OF MANUFACTURING A CERAMIC ARTICLE

(71) Applicant: General Electric Company, Evendale, OH (US)

(72) Inventors: Cathleen Ann Hoel, Schenectady, NY (US); Clifford Takashi Tanaka, Cincinnati, OH (US); Michael Joseph O'Brien, Halfmoon, NY (US); Sara Kelly Peterson, Schenectady, NY (US); Jose A. Sanchez, Schenectady, NY (US)

(21) Appl. No.: 19/034,075

(22) Filed: Jan. 22, 2025

(51) Int. Cl. C04B 35/18; C04B 35/64; C04B 38/10; C04B 41/45; C04B 41/49

(52) U.S. Cl. CPC C04B 35/18; C04B 35/64; C04B 38/10; C04B 41/4515; C04B 41/4961; C04B 2235/3463; C04B 2235/60

(57) ABSTRACT

Methods of manufacturing ceramic articles are presented. For example, a method of manufacturing a ceramic article may include layering a ceramic material in a plurality of layers along a build direction, the plurality of layers forming a green component; firing the green component at a first temperature to form a porous sintered component; infiltrating the porous sintered component with a preceramic material to form an infiltrated component; and firing the infiltrated component at a second temperature to form the ceramic article.

### FIELD

The present disclosure relates to ceramic articles, and more particularly, to methods of manufacturing ceramic articles to improve their strength.

### BACKGROUND

Ceramic articles, such as monolithic ceramics and ceramic matrix composites (“CMCs”), have high temperature capability and are light weight. Ceramic articles are thus an attractive material for various applications, such as for components in gas turbine engines where temperature durability and weight are important considerations. Current methods of preparing monolithic ceramics typically involve three-dimensional (3D) printing a green component, thermally treating the green component, and densifying the thermally treated component by infiltration with an infiltrant.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1A provides a schematic side view of a multilayer green component in accordance with an exemplary aspect of the present disclosure.

FIG. 1B provides a schematic illustration of firing the green component of FIG. 1A to form a sintered component in accordance with an exemplary aspect of the present disclosure.

FIG. 1C provides a schematic illustration of infiltrating the sintered component of FIG. 1B to form an infiltrated component in accordance with an exemplary aspect of the present disclosure.

FIG. 1D provides a schematic illustration of firing the infiltrated component of FIG. 1C to form a ceramic article in accordance with an exemplary aspect of the present disclosure.

FIG. 2A provides a schematic side view of a preceramic resin disposed in a solvent to form a preceramic solution in accordance with an exemplary aspect of the present disclosure.

FIG. 2B provides a schematic illustration of disposing a sintered component in a preceramic solution in accordance with an exemplary aspect of the present disclosure.

FIG. 2C provides a schematic side view of a sintered component disposed in a preceramic solution inside a vacuum chamber in accordance with an exemplary aspect of the present disclosure.

FIG. 3A provides a flowchart diagram showing a method of manufacturing a ceramic article in accordance with an exemplary aspect of the present disclosure.

FIG. 3B provides a flowchart diagram showing another exemplary method of manufacturing a ceramic article.

### DETAILED DESCRIPTION

Generally, additively manufactured ceramic articles are built layer-by-layer, for example, through successive printing of ceramic layers. Poor adhesion of microstructures between build layers can result in a ceramic article having low flexural strength, particularly in a direction perpendicular to the build layers. Anisotropic particles, such as whiskers, can especially reduce microstructure adhesion between build layers and thereby decrease the flexural strength of the resulting ceramic article.

Thus, an improved method of preparing ceramic articles is desirable in the art.

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a,” “an,” and “the” include plural references unless the context clearly dictates otherwise.

The term “at least one of” in the context of, e.g., “at least one of A, B, and C” refers to only A, only B, only C, or any combination of A, B, and C.

Chemical elements are discussed in the present disclosure using their common chemical abbreviation, such as commonly found on a periodic table of elements. For example, hydrogen is represented by its common chemical abbreviation H; helium is represented by its common chemical abbreviation He; and so forth.

Ceramics are particularly suitable for higher temperature applications. Additionally, ceramic materials are lightweight compared to superalloys and refractory metals yet can still provide strength and durability to the component made therefrom. Therefore, among other applications, such materials are currently being considered for many aerospace components used in higher temperature applications, such as structural elements of thermal protection systems, or other like components, that would benefit from the lighter-weight and higher temperature capability these materials can offer.

As described herein, the presently disclosed subject matter involves the use of additive manufacturing machines or systems. As used herein, the term “additive manufacturing,” which is also referred to herein as three-dimensional (3D) printing, refers generally to manufacturing technology in which components are manufactured in a layer-by-layer manner. As used herein, a “working surface” is intended to denote a surface onto which a ceramic slurry may be deposited during additive manufacturing processes. The working surface may include a working platform of a 3D printer or a printed ceramic layer. As used herein, a “binder” denotes at least one material that binds the ceramic particles together in the unfired state.

An exemplary additive manufacturing machine may be configured to utilize any suitable additive manufacturing technology. Additively manufactured objects are generally monolithic in nature and may have a variety of integral sub-components.

Additionally or alternatively, suitable additive manufacturing technologies may include, for example, Vat Photopolymerization (VPP), which may include Digital Light Processing (DLP) technology, stereolithography (SLA), or other technologies; Fused Deposition Modeling (FDM) technology; Direct Energy Deposition (DED) technology; Laser Engineered Net Shaping (LENS) technology; Laser Net Shape Manufacturing (LNSM) technology; Direct Metal Deposition (DMD) technology; Binder Jet Printing (BJP); ink jet deposition; and other additive manufacturing technologies that utilize an energy beam or other energy source to bond or solidify into a shape an additive manufacturing material such as a powder material. In fact, any suitable additive manufacturing modality may be utilized with the presently disclosed subject matter.

Additive manufacturing technology may generally be described as fabrication of objects by building objects point-by-point, line-by-line, layer-by-layer, typically in a vertical direction. Other methods of fabrication are contemplated and within the scope of the present disclosure. For example, although the discussion herein refers to the addition of material to form successive layers, the presently disclosed subject matter may be practiced with any additive manufacturing technology or other manufacturing technology, including layer-additive processes, layer-subtractive processes, or hybrid processes.

As an example, in additive manufacturing techniques, a layer, typically microns to millimeters thick, of a ceramic slurry having a binder (such as a light-curable binder) is deposited onto a working surface. For instance, the ceramic particles are generally mixed with the binder to form the ceramic slurry, such as a light-curable ceramic slurry. Once the layer of slurry has been deposited, it may be cured, that is, solidified, such as by heating, by reacting with moisture in the ambient environment, or by irradiating with electromagnetic radiation having a suitable wavelength (e.g., ultraviolet, visible) to initiate polymerization of the binder. All or only selected portions of the layer may be subjected to curing to form a layer of a “green” (unfired) ceramic material. Subsequently, another layer of the slurry is deposited over the previous layer of the green ceramic, the new layer is selectively cured, and the layer-by-layer process is repeated until the desired structure of a green ceramic article is achieved. The green ceramic article may be partially fired to achieve a “brown” ceramic article, and then fully fired (e.g., sintered) to achieve the final ceramic article.

The binder (which term is intended to include precursor materials that ultimately form a binder during subsequent processing) allows the ceramic particles to adhere to one another after deposition onto the working surface, thereby forming a green ceramic article. An example of a binder includes an organic resin, which typically includes one or more organic compounds that are convertible to polymers. In certain embodiments, the binder includes a mixture of mono-, di- and/or multi-functional acrylates and/or methacrylates that are capable of curing via a free radical mechanism. These acrylates and methacrylates may be monomeric, oligomeric or polymeric in nature. Examples of materials that may be used in formation of the binder include tricyclodecane dimethanol diacrylate, bisphenol A ethoxylate diacrylate, isobornyl acrylate, isobornyl methacrylate, diurethane dimethacrylate, trimethylolpropane ethoxylate triacrylate, acrylated polyurethane, and acrylated polyester. Optionally, multi-functional thiols capable of reacting with the acrylates and methacrylates via the thiol-ene reaction may be added as well. Examples include trimethylolpropane tris(2-mercaptoacetate) and trimethylolpropane tris(3-mercaptopropionate).

In another embodiment the binder contains cationically curable monomers such as epoxies, oxetanes, and/or vinyl ethers. Examples of such monomers include 3,4-epoxycyclohexylmethyl 3,4-epoxycyclohexane-carboxylate, hydrogenated bisphenol A diglycidyl ether oligomer, 3-ethyl-3-oxetanemethanol, and 1,4-cyclohexane dimethanol divinyl ether. Optionally, polyols such as poly(tetrahydrofuran) and/or polycaprolactonetriol may also be included.

In certain embodiments, the slurry disclosed herein includes a hybrid binder. The term “hybrid binder,” as used herein, refers to a binder that includes an organic resin mixed with a reactive siloxane. In a light-cured slurry system, for instance, the organic resin component and the reactive siloxane component polymerize when the photoinitiator of the ceramic slurry is exposed to light in the photoactivation wavelength range, such as ultraviolet light in a so-called “UV-cured” formulation. The reactive siloxane component may include a multi-functional, short (e.g., between approximately 3 and approximately 8 siloxane (Si—O) units), cyclic siloxane, or a multi-functional, longer, straight-chain silicone polymer, capable of copolymerizing with the organic resin component. For example, in certain embodiments, the reactive siloxane may include 2, 3, 4, 5, 6, 7, 8, or more functional groups (e.g., vinyl groups) capable of polymerizing (e.g., copolymerizing or homopolymerizing) under the curing conditions. The reactive siloxane component of the disclosed hybrid binder may include one or more of: tetravinyltetramethyl cyclotetras oxane (D4^{Vi}), tetrakis(vinyldimethylsiloxy) silane (M₄^{Vi}Q), vinylmethoxysiloxane homopolymer (ViOMe, available as part number VMM-010 from Gelest of Morrisville, Pa.), vinylmethylsiloxane cyclics (Dₓ^{Vi} cyclics, available as part number VMS-005 from Gelest), mixed linear and cyclic siloxanes from the hydrolysis of mercaptopropylmethyldimethoxysilane (Dₓ′), and methacrylate functional silicone resins. While the organic resin portion of the hybrid binder decomposes and volatilizes during partial firing, the siloxane portion is converted to silica that is disposed about (e.g., between, around) the mixture of the ceramic particles to enhance the handling strength of the brown ceramic part relative to similar parts made with non-hybrid binders (e.g., containing organic resin alone).

In embodiments in which the slurry formulation is curable by exposure to electromagnetic radiation, the disclosed slurry generally includes at least one photoinitiator. The photoinitiator may include any suitable structure capable of absorbing light (e.g., UV, visible light) emitted by the activation energy source and, in response, promoting curing of the binder. For example, in certain embodiments, the photoinitiator may be or include: 2-hydroxy-2-methylpropiophenone (HMPP); phenyl bis(2,4,6-trimethylbenzoyl) phosphine oxide (PBTMBPO) (e.g., Omnirad 819, by iGM Resins); 2-hydroxy-2-methyl-1-phenyl-1-propanone (e.g., Omnirad 1173); diphenyl(2,4,6-trimethylbenzoyl) phosphine oxide (e.g., Omnirad TPO); or 1-hydroxycyclohexyl phenyl ketone (e.g., Omnirad 184) or other suitable photoinitiators. In certain embodiments, a photosensitizer and/or photoacid generator may be used in conjunction with the photoinitiator to facilitate curing of the slurry. For example, in certain embodiments, the slurry may include 4-benzoyl-4′methyl-diphenyl sulfide, isopropylthioxanthone, or 9,10-diethoxyanthracene as a photosensitizer. In certain embodiments, the slurry may include one or more diaryliodonium and triarylsulfonium salts, such as, (p-methylphenyl) iodonium tetrakis(pentafluorophenyl) borate, or sulfonium salts UVI-6976 or UVI-6990 (available from Dow Chemical, Midland, Mich., U.S.A.) as a photoacid generator. In certain embodiments, the light-curable ceramic slurry may include one or more of Omnicat 432 and 550 (available from IGM Resins, Waalwijk, The Netherlands), PAG 290 (available from BASF), SL-6992 (available from Esstech, Inc., Essington, Pa., U.S.A.), or iodonium salts Omnicat 250 (available from iGM Resins), Omnicat 440 (available from iGM Resins), or UV9380C (Momentive Performance Materials, Waterford, N.Y., U.S.A.) as a photoacid generator.

The slurries may contain optional additives such as dispersants, dyes and stabilizers. Typical materials that serve these functions and their corresponding concentrations will be readily known or discernable by practitioners in the art. In some embodiments, a dispersant may be used to alter the viscosity of the ceramic slurry. A dispersant is any chemical or mixture of chemicals that can alter the rheological properties of a slurry when added in small proportions, typically less than 5 wt % of the entire slurry. The dispersant choice will depend on the properties of the ceramic particle surfaces and binder as well as the desired viscosity at certain shear rates and rheological behavior. Without limitation, examples of dispersants include Triton™ X-100 (Dow Chemical Company), Variquat® products (Evonik Industries), Jeffamine® (Huntsman), oleyl amine, oleic acid, stearic acid, Hypermer™ KD products (Croda), Solpserse™ products (Lubrizol), DISPERBYK™ products (BYK), and Silwet™ (Momentive Performance Materials Inc.).

The present disclosure is generally related to manufacturing ceramic articles using additive manufacturing.

As previously described, additive manufacturing allows for the layer-by-layer building of a green body structure, potentially having more complex geometries and intricacies beyond the limits of other manufacturing techniques (e.g., molding techniques). After printing, the green body structure may be subjected to a burnout process to remove binder material from the component. Subsequently, the component may be subjected to firing at a higher temperature to sinter and fuse the ceramic particles together, forming a microstructure with strength. Subsequently, the component can be infiltrated, such as through melt infiltration, reaction-bonding, chemical vapor infiltration, and other methods to reduce porosity in the component and increase the strength of the component. Additive manufacturing techniques can provide the ability to manufacture complex ceramic articles without the use of molds, while also decreasing manufacturing costs due, in part, to the use of less tooling and material (e.g., no metal die and molds are used and less ceramic slurry is used) and to the short processing times associated with 3D printing.

The present disclosure is related to methods of forming ceramic articles that include infiltration with a preceramic material such as a polysiloxane and firing in ambient air, which in the case of polysiloxane infiltration can convert the polysiloxane to silica. Other preceramic materials may be used as well. Using the methods as described herein advantageously and unexpectedly allows for large increases in strength with only slight increases in component density. That is, the present disclosure beneficially provides a higher strength to density ratio in ceramic articles.

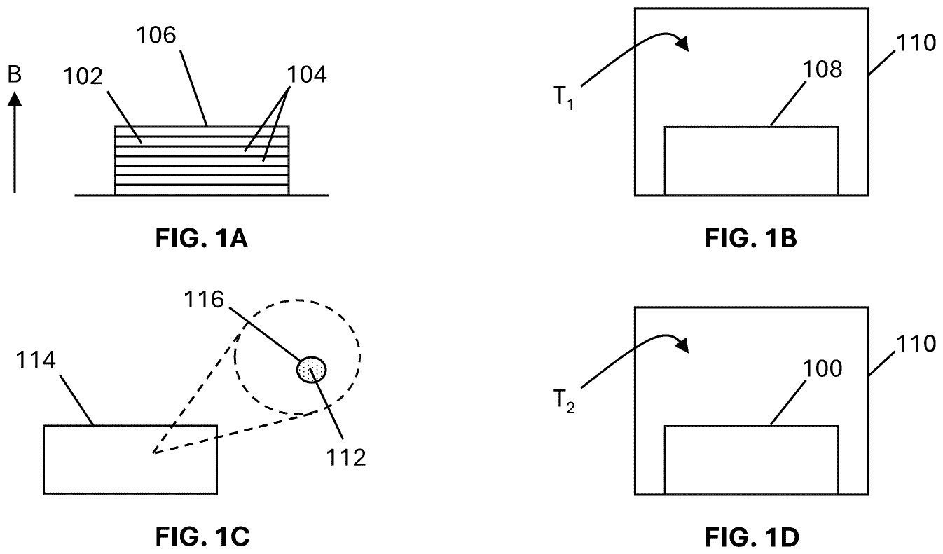

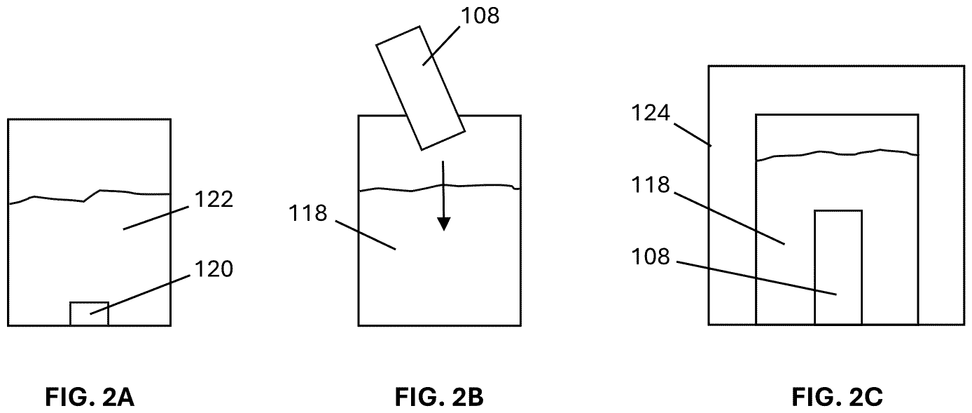

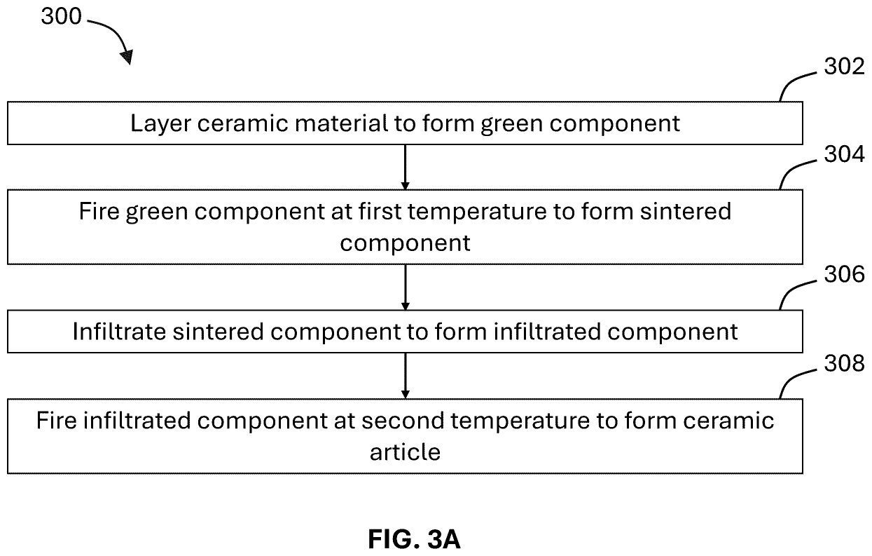

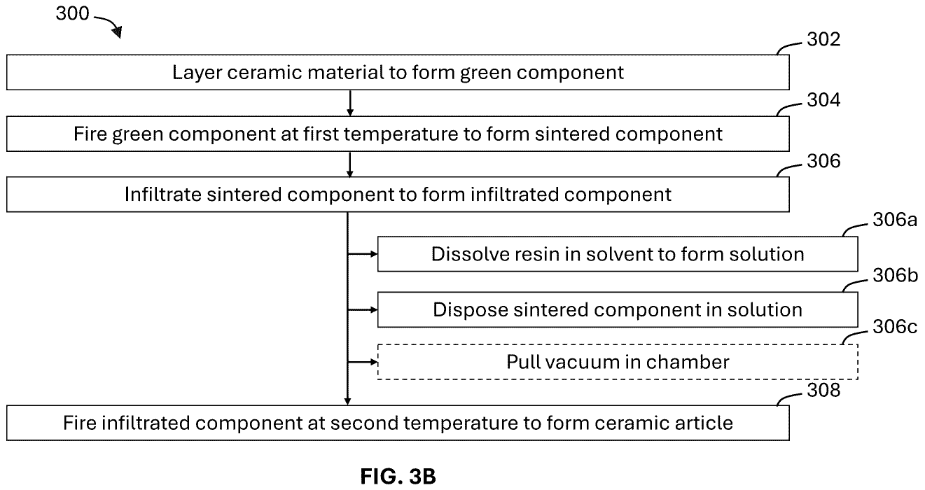

Referring now to the drawings, wherein identical numerals indicate the same elements throughout the figures, FIGS. 1A through 2C depict formation of a ceramic article 100 in accordance with exemplary aspects of the present disclosure. FIGS. 3A and 3B provide flow charts illustrating methods of manufacturing ceramic articles in accordance with exemplary aspects of the present disclosure. More particularly, FIG. 3A illustrates a method 300, and FIG. 3B illustrates the method 300 with details regarding component infiltration that may be performed as part of the method 300.

In general, the method 300 will be described herein with reference to the ceramic article 100 described with reference to FIGS. 1A through 2B. However, it will be appreciated by those of ordinary skill in the art that the disclosed method 300 may generally be utilized with any suitable ceramic article. In addition, although FIGS. 3A and 3B depict steps performed in a particular order for purposes of illustration and discussion, the methods discussed herein are not limited to any particular order or arrangement unless otherwise specified in the claims. One skilled in the art, using the disclosures provided herein, will appreciate that various steps of the methods disclosed herein can be omitted, rearranged, combined, and/or adapted in various ways without deviating from the scope of the present disclosure.

As shown in FIGS. 1A, 3A, and 3B, the method 300 of manufacturing a ceramic article includes at block 302 layering a ceramic material 102 in a plurality of layers 104 along a build direction B. The plurality of layers 104 form a green component 106. As described in greater detail herein, layering the ceramic material 102 may be part of an additive manufacturing process, also referred to as a 3D printing process. That is, the green component may be additively manufactured using fine ceramic particles (and/or a binder) via a vat polymerization process (VPP), which can include Digital Light Processing (DLP), stereolithography (SLA), and other technologies; binder jet printing (BJP); powder bed fusion (PBF); a selective laser melting (SLM) technology; a selective laser sintering (SLS) technology; fused deposition melting (FDM) technology; direct energy deposition (DED) technology; laser engineered net shaping (LENS) technology; laser net shape manufacturing (LNSM) technology; or other additive manufacturing technology. For instance, the layering of the ceramic material 102 in method 300 may be accomplished by VPP, where a build platform or working surface is lowered into a vat of the ceramic material 102 and a light or energy source (such as an ultraviolet (UV) light source) selectively cures the ceramic material 102 into a solid layer, with the build platform or working surface lowered into the vat after each new layer is cured. The VPP process may be DLP, which can cure an entire layer of the ceramic material 102 at once; SLA, which uses a laser that rasters to cure a geometry slice; or another VPP process.

In some embodiments, the ceramic material 102 may be a ceramic slurry formed from, e.g., one or more ceramic powders and, optionally, one or more additives or other constituents. For instance, in some embodiments, the ceramic material 102 includes a porogen. A porogen can increase porosity in a sintered component, which can reduce the density of a final ceramic article; however, increased porosity in a sintered component can also allow greater infiltration with a selected infiltrant during a post-sinter process. The porogen may be within a range of about 10 volume percent (vol %) to about 25 vol % of the ceramic material 102, such as about 10 vol %, about 12 vol %, about 15 vol %, about 18 vol %, about 20 vol %, about 23 vol %, or about 25 vol %. The amount of porogen may be selected to achieve a desired balance of density and strength, e.g., by creating additional porosity for infiltration with the desired infiltrant (as described in greater detail herein) to achieve increases in strength of the ceramic article without corresponding increases in density of the ceramic article.

In some embodiments, the ceramic material 102 includes particular constituents to produce a certain ceramic upon processing (e.g., after firing and infiltration). For example, the ceramic material 102 may include alumina to produce an aluminosilicate after processing as described in greater detail below. As another example, the ceramic material 102 may include alumina and silica, which may be infiltrated with silicone resin to produce an aluminosilicate ceramic article that may have a different silicate concentration than a ceramic article formed from a ceramic material 102 that did not include silica. In various embodiments, the ceramic material 102 may include at least one of alumina, silica, zirconia, stabilized zirconia, silicon carbide, silicon nitride, calcium phosphate, a glass, aluminum nitride, yttria, ceria, rare earth oxide, alkali oxide or carbonate, alkaline oxide or carbonate, or combinations thereof.

As previously described, in at least some embodiments, the ceramic material 102 may also include a porogen. For example, a ceramic material 102 may include alumina, about 8 vol % silica, and about 20 vol % of a porogen. The ceramic material 102 may include other constituents as well; for instance, in some embodiments, the ceramic material 102 may include whiskers or chopped fibers, such as about 40 vol %, about 20 vol %, about 15 vol %, about 10 vol % or less of whiskers. As an example, the ceramic material 102 may include whiskers within a range of about 1 vol % to about 40 vol % of the ceramic material.

Referring to FIGS. 1A, 3A, and 3B, the method 300 also includes at block 304 firing the green component 106 at a first temperature T₁ to form a porous sintered component 108. In the example of FIG. 1B, firing the green component 106 is performed in a chamber 110, in which the temperature and atmosphere may be adjusted to burn out the organics, etc. in the green component 106. For example, the atmosphere may be ambient air, but in other embodiments, the atmosphere may include other constituents, which can impact the resulting component makeup. For instance, oxidizing ambient air during firing at the first temperature T₁ can produce a sintered component having silica or a silicate, but including other compounds in the atmosphere could produce a carbide or nitride sintered component.

As shown in FIGS. 1C, 3A, and 3B, the method 300 further includes at block 306 infiltrating the porous sintered component 108 with an infiltrant 112 to form an infiltrated component 114. Referring particularly to FIG. 1C, the infiltrant 112 is pulled into pores 116 of the porous sintered component 108. The pores 116 may be left in or formed in the porous sintered component 108 following the firing or burnout at block 304 of the method 300, which removes binder materials, etc. from the green component 106 to form the porous sintered component 108.

In some embodiments, the infiltrant 112 is a preceramic material such as a polysiloxane, a polysilazane, a borazine-modified hydridopolysilazane, a polysilane, a polycarbosilane, a suspended silicate, a polyborazylene, a polyvinylborazine, or a decaborane-based polymer. That is, the preceramic material may be chosen to form a material containing silicon (Si), carbon (C), boron (B), or nitrogen (N) upon firing, such as a silicate, BN, or BCN-type compound. For example, the infiltrant 112 may be silicone or the like. Thus, in at least some embodiments, the exemplary green component 106 described above formed from ceramic materials 102 including alumina, and optionally other ceramic materials such as silica and/or an additive such as a porogen and/or whiskers, can be fired to form the porous sintered component 108, which may be infiltrated with a polysiloxane, a polysilazane, a borazine-modified hydridopolysilazane, a polysilane, a polycarbosilane, or a suspended silicate such as water glass to form an aluminosilicate infiltrated component 114. In other embodiments not containing alumina, another silicate can be formed, even in embodiments in which the ceramic material 102 does not include silica but the infiltrant 112 is a polysiloxane, a polysilazane, a borazine-modified hydridopolysilazane, a polysilane, a polycarbosilane, or a suspended silicate. Further, as stated above, a preceramic material or infiltrant 112 not containing Si may be chosen, such as a polyborazylene, a polyvinylborazine, or a decaborane-based polymer to obtain a desired ceramic article 100.

It will be appreciated that infiltrating the porous sintered component 108 as shown at block 306 of method 300 may be a minimal infiltration of the porous sintered component 108. That is, rather than numerous infiltrations to fill as many pores 116 as possible, the porous sintered component 108 may be infiltrated only a few times, such as ten times or less, such as five times, four times, three times, twice, or only once (i.e., as few as a single infiltration), to only slightly increase the ceramic article's density. The minimal infiltration of the porous sintered component 108 with an infiltrant 112 as described herein may produce a sufficient increase in article strength without unduly increasing the ceramic article's density. For instance, using the method 300 described herein, minimal infiltration minimally increases density but provides an unexpected or unprecedented (or more than minimal) increase in strength. Although a single infiltration is contemplated, it will be understood that more than one infiltration, such as two, three, four, or even ten infiltrations, may minimally increase density but more than minimally boost ceramic article strength, e.g., the porous sintered component 108 may be infiltrated as described herein in a manner that the increase in the ceramic article's strength is far greater than the increase in the ceramic article's density. That is, the minimal increase in article density compared to the increase in article strength is significant, rather than an exact number of infiltrations.

As a result of the post-sinter process, the infiltrated component 114 is less porous than the sintered component 108. However, the infiltrated component 114 may still exhibit a fairly high porosity, e.g., compared to conventional ceramic articles. In various embodiments, the infiltrated component 114 has greater than 10% porosity, such as at least 15% porosity, at least 18% porosity, at least 20% porosity, at least 25% porosity, or at least 30% porosity.

FIGS. 1D, 3A, and 3B illustrate that the method 300 includes at block 308 firing the infiltrated component 114 at a second temperature T₂ to form the ceramic article 100. As shown in FIG. 1D, the infiltrated component 114 is fired in the chamber 110, or another suitable chamber, in which the temperature and atmosphere are adjusted, e.g., to convert the infiltrant 112 to a desired composition for the ceramic article 100.

In some embodiments, the first temperature T₁ used in the first firing (at block 304 of method 300) is greater than the second temperature T₂ used in the second firing (at block 308 of method 300). For example, the first temperature T₁ may be at least about 1500° C., and the second temperature T₂ may be at least about 1000° C. Other temperatures may be used as well, e.g., the first temperature T₁ may be greater than 1500° C., such as about 1600° C., about 1750° C., about 2000° C., or greater, and the second temperature T₂ may be greater than 1000° C. such as about 1200° C., about 1300° C., about 1500° C., or greater. In appropriate embodiments, lesser temperatures for at least one of the first temperature T₁ or the second temperature T₂ may be used as well, e.g., the first temperature T₁ may be less than 1500° C., and/or the second temperature T₂ may be less than 1000° C. The different temperatures may reflect different goals for each firing. For instance, the first firing may be performed at a higher temperature than the second firing to complete burnout and/or to form certain ceramics, such as aluminosilicate or another silicate as described herein. The second, lower firing temperature may be sufficient to produce silica or the like from the infiltrant 112.

In other embodiments, the first temperature T₁ and the second temperature T₂ are different, but the second temperature T₂ is greater than the first temperature T₁. For example, the second temperature T₂ may be at least about 1500° C., and the first temperature T₁ may be at least about 1000° C.; other temperature values may be used as well, e.g., depending on the ceramic material 102 and the infiltrant 112. In still other embodiments, the first temperature T₁ and the second temperature T₂ are the same, e.g., each of the first temperature T₁ and the second temperature T₂ may be about 1500° C., although, as stated, other temperature values may also be used.

As described above, after infiltrating the porous sintered component 108 as shown at block 306 of method 300 and firing the infiltrated component 114 as shown at block 308, the resulting ceramic article 100 has an increased strength that is disproportional to an increase in its density compared to an uninfiltrated article. For instance, where the porous sintered component 108 has a first density and a first specific strength and the ceramic article 100 has a second density and a second specific strength, the second density of the ceramic article 100 is greater than the first density of the porous sintered component 108, but the second density of the ceramic article 100 is about 20% or less greater than the first density of the porous sintered component 108. As examples, the second density of the ceramic article 100 may be about 20% or less greater than the first density of the porous sintered component 108, such as about 15% or less greater than the first density of the porous sintered component 108, about 12% or less greater than the first density of the porous sintered component 108, about 10% or less greater than the first density of the porous sintered component 108, about 8% or less greater than the first density of the porous sintered component 108, about 5% or less greater than the first density of the porous sintered component 108, or about 3% or less greater than the first density of the porous sintered component 108.

However, the ceramic article 100 has an increase in specific strength compared to the porous sintered component 108 that is much greater than the increase in density. For example, for loads applied either parallel to or perpendicular to the build layers of the ceramic article 100, the second specific strength of the ceramic article 100 is at least 45% greater than the first specific strength of the porous sintered component 108, such that the second specific strength of the ceramic article 100 is at least about 145% of the first specific strength of the porous sintered component 108. In various embodiments, the second specific strength of the ceramic article 100 may be about 45% greater than the first specific strength of the porous sintered component 108, about 50% greater than the first specific strength of the porous sintered component 108, about 65% greater than the first specific strength of the porous sintered component 108, about 70% greater than the first specific strength of the porous sintered component 108, about 80% greater than the first specific strength of the porous sintered component 108, about 90% greater than the first specific strength of the porous sintered component 108, about 100% greater than the first specific strength of the porous sintered component 108, about 125% greater than the first specific strength of the porous sintered component 108, about 150% greater than the first specific strength of the porous sintered component 108, about 160% greater than the first specific strength of the porous sintered component 108, or more.

Thus, for a relatively small increase in density, such as 20% or less, following infiltration and firing, the ceramic article 100 has a relatively large increase in specific strength, such as 45% or more, compared to the porous sintered component 108. As discussed herein and as particularly discussed below with respect to the Examples, the density of the ceramic article 100 can vary depending on the constituents of the ceramic material 102 used to form the ceramic article 100 (e.g., whether the ceramic material 102 does or does not include a porogen and/or whiskers), and the specific strength of the ceramic article 100 can vary with respect to the direction of the applied load relative to the build layers. In some embodiments, compared to the porous sintered component 108, the ceramic article 100 has an increase in density of about 3% and, for a load applied parallel to the build layers, an increase in specific strength of about 53%. In other embodiments, compared to the porous sintered component 108, the ceramic article 100 has an increase in density of about 3% and, for a load applied perpendicular to the build layers, an increase in specific strength of about 72%. In yet other embodiments, compared to the porous sintered component 108, the ceramic article 100 has an increase in density of about 9%, and, for a load applied parallel to the build layers, an increase in specific strength of about 68%, while for a load applied perpendicular to the build layers, the ceramic article 100 has an increase in specific strength of about 100%. In still other embodiments, compared to the porous sintered component 108, the ceramic article 100 has an increase in density of about 10.5% and an increase in specific strength of about 158%.

Referring now to FIGS. 2A through 2C and FIG. 3B, an exemplary infiltration process will be described in greater detail. In some embodiments, infiltrating the porous sintered component 108 as shown at block 306 of method 300 includes disposing the porous sintered component 108 in a preceramic solution 118. For example, as shown in FIGS. 2A and 3B, the preceramic solution 118 is formed by, at block 306a, dissolving a silicone resin 120 in a solvent 122. For instance, a solid block of the silicone resin 120 may be dissolved in a liquid solvent to form a liquid silicone preceramic solution 118 for infiltrating the porous sintered component 108. As shown in FIG. 2B and at block 306b in FIG. 3B, after forming the preceramic solution 118, the porous sintered component 108 is disposed in the preceramic solution 118, which may be positioned in a vacuum chamber 124. In some embodiments, as illustrated in FIG. 2C and at block 306c in FIG. 3B, the method 300 includes pulling a vacuum in the vacuum chamber 124 to draw the preceramic solution 118 into the porous sintered component 108. That is, air may be removed from the vacuum chamber 124 and the pressure may be lowered in the vacuum chamber 124 to draw the preceramic solution 118 into the pores 116 of the porous sintered component 108 such that the preceramic infiltrates the porous sintered component 108. However, use of vacuum conditions to draw the infiltrant 112 into the porous sintered component 108 is optional; the vacuum can speed up infiltration of the porous sintered component 108 with the infiltrant 112, but infiltration without a vacuum (e.g., over a longer period of time) may be sufficient.

In embodiments utilizing a silicone resin 120 to form the preceramic solution 118, the silicone resin 120 may have a composition to result in a high char yield after the second firing at the second temperature T₂ as shown at (308) of method 300. For example, the silicone resin 120 may be selected such that less than about 35% of a mass of the silicone resin 120 is lost in firing the infiltrated component 114. In other embodiments, the silicone resin 120 may have a composition such that less than about 30%, in some embodiments less than about 25%, in some embodiments less than about 20%, and in some embodiments less than about 15%, of the mass of the silicone resin 120 is lost in firing the infiltrated component 114. Further, other suitable silicone preparations (e.g., other than a silicone resin dissolved in a solvent) may be used to form the infiltrant that results in a high char yield.

Thus, the method 300 can be used to form ceramic articles, such as the ceramic article 100. A ceramic article 100 formed as described above includes a ceramic structure having a plurality of pores, at least a portion of which contain an infiltrant. In some embodiments, such as embodiments in which the ceramic materials 102 include alumina and the infiltrant 112 is silicone resin, the ceramic structure includes aluminosilicate, and some of the plurality of pores includes may include residual silica therein, although all silica could react in the second firing such that the pores include aluminosilicate therein. As described in greater detail herein, the ceramic structure of the ceramic article 100 could include other silicates and/or other ceramics.

Ceramic articles formed as described herein, such as by using the method 300, can have a relatively low density and a relatively high strength, or a high strength to density ratio compared to known articles. That is, ceramic articles formed as described herein may be stronger than conventional articles having similar densities or may have a lower density than known articles of similar strengths.

### Examples

Embodiments will be further clarified by the following examples. It should be understood that these examples are not limiting to the embodiments described above.

Table 1 provides data produced from testing ceramic articles comprising alumina and 15 vol % whiskers that were not infiltrated with any infiltrant (“Uninfiltrated Article”) and exemplary ceramic articles formed using the methods and processes described herein (“Inventive Article”). Table 2 provides data produced from testing ceramic articles comprising alumina, 15 vol % whiskers, and 15 vol % porogen in ceramic slurry that were not infiltrated within any infiltrant (“Uninfiltrated Article”) and exemplary ceramic articles formed using the methods and processes described herein (“Inventive Article”). Table 3 provides data produced from testing ceramic articles comprising 72 wt % alumina and 28 wt % mullite with 20 vol % porogen in ceramic slurry that were not infiltrated within any infiltrant (“Uninfiltrated Article”) and exemplary ceramic articles formed using the methods and processes described herein (“Inventive Article”). In particular, for each of the Inventive Articles for which testing data is provided in Tables 1, 2, and 3, the Inventive Articles were infiltrated with a polysiloxane and, after infiltration, were fired to 1000° C. In contrast, the Uninfiltrated Articles for which data is provided in Tables 1, 2, and 3 were not infiltrated. It will be appreciated that theoretical density is the maximum density a respective article can achieve based on its atomic composition, which may be calculated by dividing a total mass of the article by unit cell volume.

TABLE 1
Testing data for Uninfiltrated vs. Inventive Articles comprising alumina
containing 15 vol % whiskers

| | | | | | Four- | | | |
|---|---|---|---|---|---|---|---|---|
| | | | | | Point | Relative | | |
| | | | Relative | Applied | Bend | Increase | | Relative |
| | Bulk | % of | Increase | Load | Flexural | in | Specific | Increase in |
| | Density | Theoretical | in | Relative to | Strength | Flexural | Strength | Specific |
| | (g/cc) | Density | Density | Build Layers | (psi) | Strength | (psi) | Strength |
| Uninfiltrated | 3.2 | 81% | N/A | Parallel | 16000 | N/A | 19750 | N/A |
| Article | 3.2 | 81% | N/A | Perpendicular | 5300 | N/A | 6542 | N/A |
| Inventive | 3.3 | 84% | 3.1% | Parallel | 24500 | 53.1% | 29326 | 48% |
| Article | 3.3 | 84% | 3.1% | Perpendicular | 9100 | 71.7% | 10892 | 66% |

TABLE 2
Testing data for Uninfiltrated vs. Inventive Articles comprising alumina containing
15 vol % whiskers and 15 vol % porogen in ceramic slurry

| | | | | | Four- | | | |
|---|---|---|---|---|---|---|---|---|
| | | | | | Point | Relative | | Relative |
| | | | Relative | Applied | Bend | Increase | | Increase |
| | Bulk | % of | Increase | Load | Flexural | in | Specific | in |
| | Density | Theoretical | in | Relative to | Strength | Flexural | Strength | Specific |
| | (g/cc) | Density | Density | Build Layers | (psi) | Strength | (psi) | Strength |
| Uninfiltrated | 2.3 | 58% | N/A | Parallel | 11000 | N/A | 18891 | N/A |
| Article | 2.3 | 58% | N/A | Perpendicular | 7600 | N/A | 13052 | N/A |
| Inventive | 2.5 | 63% | 8.7% | Parallel | 18500 | 68.2% | 29230 | 55% |
| Article | 2.5 | 63% | 8.7% | Perpendicular | 15200 | 100.0% | 24016 | 84% |

TABLE 3
Testing data for Uninfiltrated vs. Inventive Articles comprising 72 wt % alumina and
28 wt % mullite with 20 vol % porogen in ceramic slurry

| | | | | | Four- | | | |
|---|---|---|---|---|---|---|---|---|
| | | | | | Point | Relative | | |
| | | | Relative | Applied | Bend | Increase | | Relative |
| | Bulk | % of | Increase | Load | Flexural | in | Specific | Increase in |
| | Density | Theoretical | in | Relative to | Strength | Flexural | Strength | Specific |
| | (g/cc) | Density | Density | Build Layers | (psi) | Strength | (psi) | Strength |
| Uninfiltrated | 1.9 | 54% | N/A | Parallel | 4300 | N/A | 8012 | N/A |
| Article | | | | | | | | |
| Inventive | 2.1 | 59% | 10.5% | Parallel | 11100 | 158.1% | 18711 | 134% |
| Article | | | | | | | | |

As shown in Tables 1, 2, and 3, utilizing preceramic infiltration as described herein (e.g., infiltration with a polysiloxane, a polysilazane, a borazine-modified hydridopolysilazane, a polysilane, a polycarbosilane, a suspended silicate, a polyborazylene, a polyvinylborazine, or a decaborane-based polymer) can greatly increase a ceramic article's strength without a significant increase in the ceramic article's density. For example, referring to Table 1, with only a 3.1% increase in article density, for a load applied parallel to the build layers, the four-point bend flexural strength of the Inventive Article is 53.1% greater than the four-point bend flexural strength of the Uninfiltrated Article. In fact, for only slight increases in density, the Inventive Articles exhibited an increase in flexural strength of greater than 50% in each test.

Moreover, the Inventive Articles each exhibited an increase of specific strength of greater than 45% in each test, where specific strength is the four-point bend flexural strength divided by the percentage of theoretical density. For instance, the Inventive Article of Table 1 had a 48% increase in specific strength compared to the Uninfiltrated Article, for a load applied parallel to the build layers, and for a load applied perpendicular to the build layers, the Inventive Article of Table 1 had a 66% increase in specific strength compared to the Uninfiltrated Article. As shown in Table 3, with only a 10.5% increase in article density, for a load applied parallel to the build layers, the Inventive Article had a 158% increase in flexural strength and a 134% increase in specific strength compared to the Uninfiltrated Article.

Further aspects are provided by the subject matter of the following clauses:

A method of manufacturing a ceramic article comprising layering a ceramic material in a plurality of layers along a build direction, the plurality of layers forming a green component; firing the green component at a first temperature to form a porous sintered component, the porous sintered component having a first density and a first specific strength; infiltrating the porous sintered component with a preceramic material to form an infiltrated component; and firing the infiltrated component at a second temperature to form the ceramic article, the ceramic article having a second density and a second specific strength, wherein the second density of the ceramic article is less than about 20% greater than the first density of the porous sintered component, and wherein the second specific strength of the ceramic article is at least about 45% greater than the first specific strength of the porous sintered component.

The method of any preceding clause, wherein the preceramic material comprises at least one of a polysiloxane, a polysilazane, a borazine-modified hydridopolysilazane, a polysilane, a polycarbosilane, a suspended silicate, a polyborazylene, a polyvinylborazine, or a decaborane-based polymer.

The method of any preceding clause, wherein infiltrating the porous sintered component comprises disposing the porous sintered component in a preceramic solution.

The method of any preceding clause, wherein the porous sintered component is disposed in the preceramic solution in a vacuum chamber, and wherein infiltrating the porous sintered component further comprises pulling a vacuum in the vacuum chamber to draw the preceramic solution into the porous sintered component.

The method of any preceding clause, wherein the ceramic material comprises whiskers within a range of about 1 volume percent (vol %) to about 40 vol % of the ceramic material.

The method of any preceding clause, wherein the ceramic material comprises a porogen.

The method of any preceding clause, wherein the porogen is within a range of about 1 volume percent (vol %) to about 25 vol % of the ceramic material.

The method of any preceding clause, wherein the first temperature is different from the second temperature.

The method of any preceding clause, wherein the first temperature is at least about 1500° C.

The method of any preceding clause, wherein the second temperature is about 1000° C.

The method of any preceding clause, wherein the ceramic material comprises at least one of alumina, silica, zirconia, stabilized zirconia, silicon carbide, silicon nitride, calcium phosphate, a glass, aluminum nitride, yttria, ceria, rare earth oxide, alkali oxide or carbonate, alkaline oxide or carbonate, or combinations thereof.

The method of any preceding clause, wherein the infiltrated component has at least 25% porosity.

A method of manufacturing a ceramic article comprising three-dimensional (3D) printing a ceramic material along a build direction to form a green component, the green component comprising ceramic particles and a binder; firing the green component at a first temperature to form a porous sintered component, the porous sintered component having a first density and a first specific strength; infiltrating the porous sintered component with a polysiloxane to form an infiltrated component; and firing the infiltrated component at a second temperature to form the ceramic article, the ceramic article having a second density and a second specific strength, wherein the second density of the ceramic article is less than about 20% greater than the first density of the porous sintered component, and wherein the second specific strength of the ceramic article is at least about 45% greater than the first specific strength of the porous sintered component.

The method of any preceding clause, wherein the 3D printing is a vat polymerization process.

The method of any preceding clause, wherein the polysiloxane is a silicone solution.

The method of any preceding clause, wherein the silicone solution comprises a silicone resin dissolved in a solvent, and wherein the silicone resin has a char yield such that less than about 50% of a mass of the silicone resin is lost in firing the infiltrated component.

The method of any preceding clause, wherein the first temperature is different from the second temperature.

The method of any preceding clause, wherein the ceramic material comprises a porogen.

The method of any preceding clause, wherein the ceramic material comprises alumina such that the ceramic article comprises a silicate.

The method of any preceding clause, wherein infiltrating the porous sintered component is a single infiltration of the porous sintered component.

A ceramic article comprising a ceramic structure having a plurality of pores, wherein the ceramic structure includes aluminosilicate, and wherein a least a portion of the plurality of pores includes a silicate therein.

The ceramic article of any preceding clause, wherein the ceramic article has a porosity of at least 25%.

This written description uses examples to disclose the present disclosure, including the best mode, and also to enable any person skilled in the art to practice the disclosure, including making and using any devices or systems and performing any incorporated methods. The patentable scope of the disclosure is defined by the claims and may include other examples that occur to those skilled in the art. Such other examples are intended to be within the scope of the claims if they include structural elements that do not differ from the literal language of the claims, or if they include equivalent structural elements with insubstantial differences from the literal language of the claims.

We claim:

1. A method of manufacturing a ceramic article comprising:
layering a ceramic material in a plurality of layers along a build direction, the plurality of layers forming a green component;
firing the green component at a first temperature to form a porous sintered component, the porous sintered component having a first density and a first specific strength;
infiltrating the porous sintered component with a preceramic material to form an infiltrated component; and
firing the infiltrated component at a second temperature to form the ceramic article, the ceramic article having a second density and a second specific strength,
wherein the second density of the ceramic article is less than about 20% greater than the first density of the porous sintered component, and
wherein the second specific strength of the ceramic article is at least about 45% greater than the first specific strength of the porous sintered component.

2. The method of claim 1, wherein the preceramic material comprises at least one of a polysiloxane, a polysilazane, a borazine-modified hydridopolysilazane, a polysilane, a polycarbosilane, a suspended silicate, a polyborazylene, a polyvinylborazine, or a decaborane-based polymer.

3. The method of claim 1, wherein infiltrating the porous sintered component comprises disposing the porous sintered component in a preceramic solution.

4. The method of claim 3, wherein the porous sintered component is disposed in the preceramic solution in a vacuum chamber, and wherein infiltrating the porous sintered component further comprises pulling a vacuum in the vacuum chamber to draw the preceramic solution into the porous sintered component.

5. The method of claim 1, wherein the ceramic material comprises whiskers within a range of about 1 volume percent (vol %) to about 40 vol % of the ceramic material.

6. The method of claim 1, wherein the ceramic material comprises a porogen.

7. The method of claim 6, wherein the porogen is within a range of about 1 volume percent (vol %) to about 25 vol % of the ceramic material.

8. The method of claim 1, wherein the first temperature is different from the second temperature.

9. The method of claim 8, wherein the first temperature is at least about 1500° C.

10. The method of claim 8, wherein the second temperature is at least about 1000° C.

11. The method of claim 1, wherein the ceramic material comprises at least one of alumina, silica, zirconia, stabilized zirconia, silicon carbide, silicon nitride, calcium phosphate, a glass, aluminum nitride, yttria, ceria, rare earth oxide, alkali oxide or carbonate, alkaline oxide or carbonate, or combinations thereof.

12. The method of claim 1, wherein the infiltrated component has at least 25% porosity.

13. A method of manufacturing a ceramic article comprising:
three-dimensional (3D) printing a ceramic material along a build direction to form a green component, the green component comprising ceramic particles and a binder;
firing the green component at a first temperature to form a porous sintered component, the porous sintered component having a first density and a first specific strength;
infiltrating the porous sintered component with a polysiloxane to form an infiltrated component; and
firing the infiltrated component at a second temperature to form the ceramic article, the ceramic article having a second density and a second specific strength,
wherein the second density of the ceramic article is less than about 20% greater than the first density of the porous sintered component, and
wherein the second specific strength of the ceramic article is at least about 45% greater than the first specific strength of the porous sintered component.

14. The method of claim 13, wherein the 3D printing is a vat polymerization process.

15. The method of claim 13, wherein the polysiloxane is a silicone solution.

16. The method of claim 15, wherein the silicone solution comprises a silicone resin dissolved in a solvent, and wherein the silicone resin has a char yield such that less than about 50% of a mass of the silicone resin is lost in firing the infiltrated component.

17. The method of claim 13, wherein the first temperature is different from the second temperature.

18. The method of claim 13, wherein the ceramic material comprises a porogen.

19. The method of claim 13, wherein the ceramic material comprises alumina such that the ceramic article comprises a silicate.

20. The method of claim 13, wherein infiltrating the porous sintered component is a single infiltration of the porous sintered component.
